(19) United States
(12) Patent Application Publication
(10) Pub. No.: US 2026/0172732 A1
(43) Pub. Date: Jun. 18, 2026

(54) EARPHONE

(71) Applicant: Beijing Zitiao Network Technology Co., Ltd., Beijing (CN)

(72) Inventor: Shudong LIU, Beijing (CN)

(21) Appl. No.: 19/343,850

(22) Filed: Sep. 29, 2025

(30) Foreign Application Priority Data
Dec. 13, 2024 (CN) 202423095488.9

(51) Int. Cl. H04R 1/10

(52) U.S. Cl. CPC H04R 1/1016

(57) ABSTRACT

The present disclosure provides an earphone, which relates to the technical field of wearable devices. The earphone includes a main body part and a sounding part, where the main body part straddles a helix of an ear in the wearing state, and the sounding part is located at one side of the main body part facing a concha cavity of the ear; the sounding part is slidably arranged on the main body part so that the sounding part has a first state and a second state relative to the main body part, and a distance between the sounding part and an ear canal opening in the second state is smaller than a distance between the sounding part and the ear canal opening in the first state.

### CROSS-REFERENCE TO RELATED APPLICATIONS

The present application is based on and claims priority to Chinese Patent Application No. 202423095488.9, filed on Dec. 13, 2024, the disclosures of which is incorporated herein by reference in its entirety.

### TECHNICAL FIELD

Embodiments of the present disclosure relate to the technical field of wearable devices, in particular to an earphone.

### BACKGROUND

Earphones are devices that convert electrical signals into sounds, which are widely used in people's daily lives. Earphones can be used in conjunction with mobile phones, computers and other electronic devices. At present, earphones are usually open earphones to reduce damages to the ear canal and improve the comfort of earphones.

Both ear clip earphones and ear-hanging earphones need to be clipped or hung on the ears to reduce the risk of the earphones falling during sports or activities.

### SUMMARY

An embodiment of the present disclosure provides an earphone, which includes a main body part and a sounding part, where in a wearing state, the main body part straddles a helix of an ear, and the sounding part is located at one side of the main body part facing a concha cavity of the ear, where the sounding part is slidably arranged on the main body part to allow that the sounding part has a first state and a second state relative to the main body part, and a distance between the sounding part and an ear canal opening in the second state is smaller than a distance between the sounding part and the ear canal opening in the first state.

In one possible implementation, in the first state, the sounding part and the main body part clamp the ear, and in the second state, the sounding part extends below the tragus.

In one possible implementation, in the first state, at least part of the sounding part abuts against the concha cavity.

In one possible implementation, the main body part includes a first main body part and a second main body part connected with the first main body part. In the wearing state, the first main body part straddles the helix of an ear to allow that the second main body part and the sounding part extend towards the concha cavity of the ear, and the sounding part is slidably arranged on the second main body part.

In one possible implementation, one of the sounding part and the second main body part is provided with a sliding projection, another of the sounding part and the second main body part is provided with a sliding groove, and the sliding projection is slidably arranged in the sliding groove.

In one possible implementation, the sliding groove is arranged on one side of the second main body part facing the concha cavity.

In one possible implementation, the second main body part includes a first sub-part and a second sub-part, one end of the first sub-part is connected with the sounding part, and another end of the first sub-part is slidably connected with the second sub-part.

In one possible implementation, one of the first sub-part and the second sub-part is provided with at least one sliding projection, and another of the first sub-part and the second sub-part is provided with at least one sliding groove.

In one possible implementation, the at least one sliding groove includes a plurality of sliding grooves, and the plurality of the sliding grooves are arranged at intervals; and/or the at least one sliding projection includes a plurality of sliding projections, and the plurality of sliding projections are arranged at intervals.

In one possible implementation, the earphone further includes a balance part, and the balance part is connected with an end of the main body part away from the sounding part.

The technical problems solved by the earphone provided by the embodiments of the present disclosure, technical features included in the technical solutions and advantageous effects brought by the technical features are further explained in detail in the specific embodiments.

### BRIEF DESCRIPTION OF THE DRAWINGS

In order to explain the embodiments of the present disclosure or the technical solutions in the prior art more clearly, the drawings needed in the description of the embodiments or the prior art are briefly introduced below. Obviously, the drawings in the following description are some embodiments of the present disclosure, and other drawings can be obtained according to these drawings without creative labor.

FIG. 1 is a schematic diagram of an ear provided by some embodiments of the present disclosure;

FIG. 2 is a state schematic diagram I of an earphone according to some embodiments of the present disclosure;

FIG. 3 is a state schematic diagram II of an earphone provided by some embodiments of the present disclosure;

FIG. 4 is a state schematic diagram I of an earphone provided by some other embodiments of the present disclosure;

FIG. 5 is a state schematic diagram II of an earphone provided by some other embodiments of the present disclosure;

FIG. 6 is an exploded view of an earphone provided by some other embodiments of the present disclosure;

FIG. 7 is a schematic diagram of an earphone worn on an ear in a first state according to some embodiments of the present disclosure;

FIG. 8 is a schematic diagram of an earphone worn on an ear in a second state according to some embodiments of the present disclosure.

### DESCRIPTION OF REFERENCE NUMERALS

10: ear; 11: helix; 12: concha; 12a: concha cavity; 12b: cymba concha; 13: tragus; 14: antitragus; 15: antihelix; 151: upper crus of antihelix; 152: lower crus of antihelix; 16: triangular fossa; 17: helical crus; 18: ear canal opening; 19: earlobe;
1000: earphone;
100: main body part;
110: first main body part;
120: second main body part;
121: sliding groove;
122: sliding projection;
123: first sub-part;
124: second sub-part;
200: sounding part;
300: balance part.

### DETAILED DESCRIPTION

In the related art, the prior earphones are relatively simple in use posture and acoustic effect, and cannot give consideration to comfort and sound quality effect at the same time. For example, the form of earphones is open or in-ear, where the form of in-ear earphones includes semi-in-ear earphones or full-in-ear earphones. In-ear earphones provide users with better acoustic sound quality effect because the sounding part is closer to the ear canal opening, but the in-ear earphones are uncomfortable when worn for a long time. At the same time, although the open earphones can improve the comfort of a user, the open earphones lose the sound quality effect of an earphone. Therefore, the prior earphones cannot give consideration to the wearing comfort and sound quality effect of the earphone at the same time.

Based on this, the embodiments of the present disclosure provide an earphone, and the sounding part is slidably arranged on the main body part, thereby allowing position of the sounding part relative to the ear canal opening to be changed, so that the sounding part has a first state and a second state. In a case where the sounding part is in the first state, a distance between the sounding part and the ear canal opening is relatively large, and the earphone can be an open earphone, thereby improving the wearing comfort of the earphone; and in a case where the sounding part is in the second state, a distance between the sounding part and the ear canal opening is relatively small, and the earphone can be a semi-in-ear earphone or a full-in-ear earphone, thereby improving the sound quality effect of the earphone. With this arrangement, the position of the sounding part relative to the main body part can be changed, so that the earphone can be more flexibly adapted to shape and size of the ear canal opening of different users and the actual needs, and then the earphone can be freely switched between wearing comfort and sound quality effect.

In order to allow the above objects, features and advantages of the embodiments of the present disclosure to be more obvious and easier to understand, the technical solutions of the embodiments of the present disclosure are described clearly and completely with reference to the accompanying drawings. Obviously, the described embodiments are part of the embodiments of the present disclosure, but not all of them. Based on the embodiments in the present disclosure, all other embodiments obtained by ordinary skilled person in this field without creative work fall into the protection scope of this disclosure.

Some embodiments of the present disclosure provide an earphone, and a sounding part of the earphone has a first state and a second state, so that the earphone can give consideration to both comfort and sound quality effect.

Some embodiments of the present disclosure provide an earphone 1000, and the earphone 1000 may be an ear clip earphone. In order to clearly describe the wearing form of the earphone 1000, the structure of the ear and the wearing state related therein, the definitions of front side, rear side, upper side and lower side of the ear are described below.

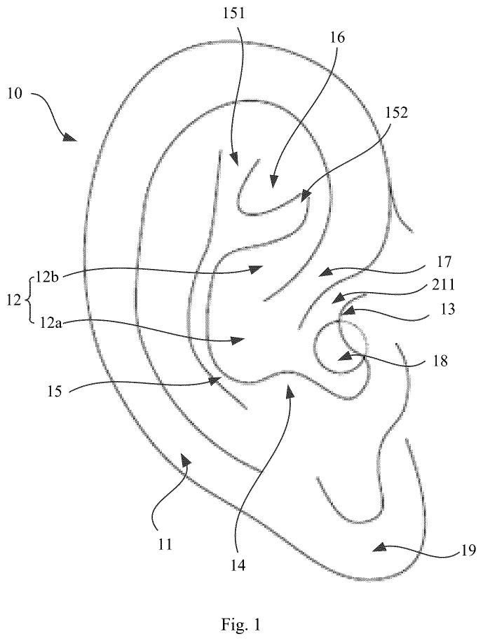

Referring to FIG. 1, the ear 10 of a user includes helix 11, concha 12, tragus 13, antitragus 14, antihelix 15, upper crus of antihelix 151, lower crus of antihelix 152, triangle fossa 16, helical crus 17, ear canal opening 18, earlobe 19 and other structures. The concha 12 may include cymba concha 12b and concha cavity 12a.

Front side and rear side of the ear are defined as follows: the “front side of the ear” described in the present disclosure is a concept relative to the “rear side of the ear”, and the former refers to the side of the ear facing away from the head, and the latter refers to the side of the ear facing the head.

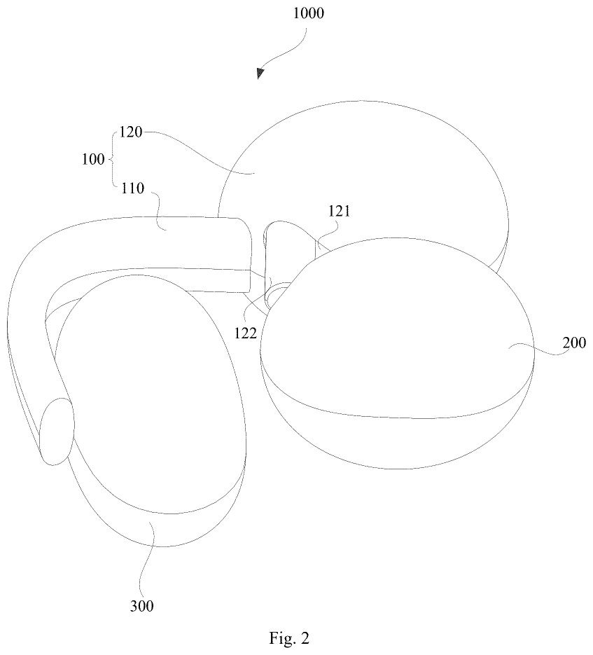

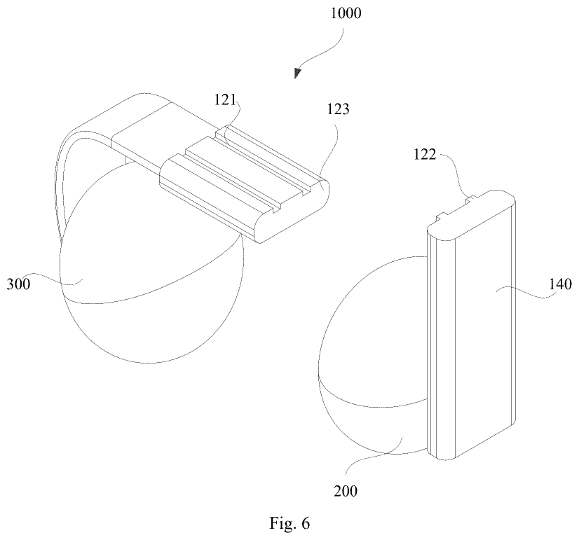

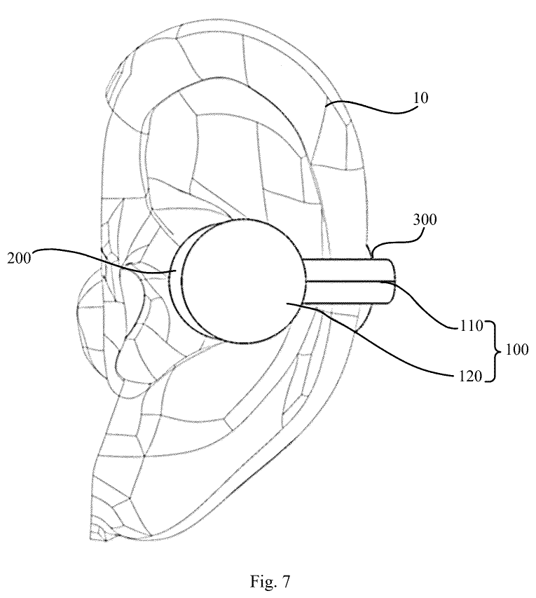

Referring to FIG. 2 and FIG. 6, the earphone 1000 provided by the embodiments of the present disclosure includes a main body part 100. The main body part 100 is the main component of the earphone 1000, and can not only clamp the ear 10 of a user, but also wire up the earphone 1000, thus improving the aesthetics of the earphone 1000.

In the wearing state, the main body part 100 straddles the helix 11 of the ear 10 and clamps the helix 11 to allow that that the earphone 1000 is an ear clip earphone.

The earphone 1000 further includes a sounding part 200. The sounding part 200 is slidably arranged on the main body part 100 and located at one side of the main body part 100 facing the concha cavity 12a of the ear 10. In this way, it is convenient for the sounding part 200 to be closer to the ear canal opening 18, so as to improve the sound quality effect of the earphone 1000. It should be understood that the sound quality effect in some embodiments may include the volume of the earphone and the clarity of the sound quality of the earphone.

In some embodiments of the present disclosure, the sounding part 200 has a first state and a second state relative to the main body part 100, and the distance between the sound emitting part 200 and the ear canal opening 18 in the second state is smaller than the distance between the sound emitting part 200 and the ear canal opening 18 in the first state. In other words, in the first state, the distance between the sounding part 200 and the ear canal opening 18 may be a first distance, and in the second state, the distance between the sounding part 200 and the ear canal opening 18 may be a second distance, where the second distance is smaller than the first distance.

In a case where the sounding part 200 is in the first state, the distance between the sounding part 200 and the ear canal opening 18 is relatively large, and the earphone 1000 can be an open earphone. The oppression of the earphone 1000 on the ear canal is greatly reduced in a case where it is worn, thereby improving the wearing comfort of the earphone 1000.

In a case where the sounding part 200 is in the second state, the distance between the sounding part 200 and the ear canal opening 18 is relatively small, and the earphone 1000 can be a semi-in-ear earphone or a full-in-ear earphone, which optimizes the sound transmission path, reduces the sound leakage, and significantly improves the sound quality effect of the earphone 1000. In this way, by changing the relative position of the sounding part 200 relative to the main body part 100, the earphone 1000 can be more flexibly adapted to shape and size of the ear canal opening of different users and the actual needs, so that the earphone 1000 can be freely switched between wearing comfort and sound quality effect.

In one possible implementation, in a first state, the sounding part 200 and the main body part 100 clamp the ear 10. By using the sounding part 200 and the main body part 100 to clamp the ear 10 together, the stability of the earphone 1000 in the wearing state can be improved, and the earphone 1000 can be effectively prevented from slipping or loosening in the wearing process, especially in the case of strenuous exercise or frequent head activities, a stable wearing state can be still maintained, thereby providing users with a continuous and uninterrupted listening experience.

In the second state, the sounding part 200 can extend below the tragus, and the sounding part 200 is similar to earplug of an in-ear earphone. In this way, the distance between the sounding part 200 and the ear canal opening 18 can be shortened, so that the sounding part 200 can fit into the ear canal more deeply, achieving higher sound insulation effect and sound immersion, and improving the sound quality effect of the earphone 1000. At the same time, the sounding part 200 can be fixed on the ear by means of the tragus, so as to improve the wearing stability of the earphone 1000.

In other embodiments, in a case where the sounding part 200 is in the first state, the sounding part 200 at least partially abuts against the concha cavity 12a, that is, the sounding part 200 may fully abut against the concha cavity 12a or partially abut against the concha cavity 12a. In this way, natural shape of the auricle is used as a physical support, which significantly enhances the stability of the earphone 1000 in the wearing process. This design reduces slippage or looseness of earphones caused by head movement or external interference, and ensures that users can enjoy a stable wearing experience in various dynamic scenes. In addition, securing the position of the sounding part 200 in the concha cavity is also helpful to optimize the acoustic transmission path, which can further reduce the loss of sound in the transmission process, thus providing users with better acoustic quality effects and ensuring that users can receive clearer and more accurate audio information.

It should be noted that the earphone 1000 usually includes a balance part 300, and the balance part 300 is connected with the end of the main body part 100 away from the sounding part 200, that is, the balance part 300 and the sounding part 200 are respectively located on both sides of the main body part 100, and the balance part 300 and the sounding part 200 are connected by the main body part 100. In this way, in a case where the sounding part 200 is in the first state, the sounding part 200 at least partially abuts against the concha cavity, and the sounding part 200 can co-act with the balance part 300 located at the rear side of the ear to construct a clamping structure for clamping the ear 10, and further, the wearing stability of the earphone 1000 is improved to keep the earphone 1000 closely attached to the ear, thus ensuring stable audio output and wearing experience.

In an example, the battery of the earphone 1000 can also be placed in the balance part 300 to allow that the weight of the balance part 300 and the weight of the sounding part 200 can be matched with each other. In this way, it is helpful to realize the overall weight balance of the earphone 1000, and users can feel more balanced stress by wearing it, reducing the sense of oppression or discomfort caused by uneven weight distribution, thus improving the comfort of long-time wearing.

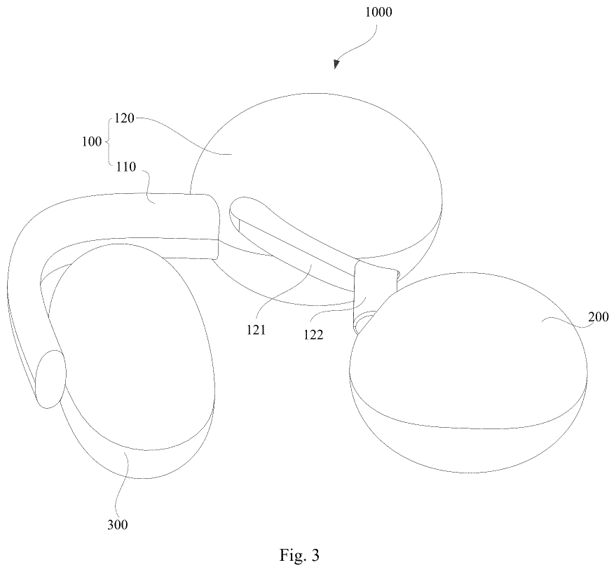

Referring to FIGS. 2 and 3, the main body part 100 includes a first main body 110 and a second main body 120, where the first main body 110 and the second main body 120 are connected with each other. In the wearing state, the first main body part 110 straddles the helix 11 of the ear 10 to allow that the second main body part 120 and the sounding part 200 extend towards the concha cavity 12a of the ear 10, so that the sounding part 200 can be closer to the concha cavity 12a, thus ensuring that users can hear clear sounds.

The sounding part 200 is slidably disposed on the second main body part 120. On the premise that the second main body part 120 extends toward the concha cavity 12a, by having the sounding part 200 disposed slidably on the second main body part 120, and the distance between the sounding part 200 and the ear canal 18 can be better adjusted by fine-tuning the sounding part 200, thereby improving the convenience of adjusting the sound quality effect of the earphone 1000.

In addition, the sounding part 200 and the second main body part 120 are independent components, so that the shape of the sounding part 200 can be better designed. This design flexibility is helpful to optimize the acoustic performance of the sounding part 200, improve the clarity of sound quality, and meet the individual needs of different users for sound quality and wearing comfort.

In some embodiments, the shapes of the sounding part 200 and the second main body part 120 can be matched with each other. On one hand, the earphone can be more harmonious and unified in appearance, which enhances the overall aesthetic feeling and the visual appeal of the product. On the other hand, the shape of the sounding part 200 can be optimized, and the interference of the sounding part 200 with the concha cavity, the tragus and the helix can be reduced, thus improving the wearing comfort of the earphone 1000.

In order to realize the sliding connection between the sounding part 200 and the second main body part 120, the sliding projection and the sliding groove can be matched with one another. Illustratively, referring to FIGS. 2 and 3, one of the sounding part 200 and the second main body part 120 is provided with a sliding projection 122, and another of the sounding part 200 and the second main body part 120 is provided with a sliding groove 121. The sliding projection 122 is slidably disposed in the sliding groove 121.

Hereinafter, taking arranging the sliding projection 122 in the sounding part 200 as an example, the sliding projection 122 is disposed on the side of the sounding part 200 facing the second main body part 120, and the sliding groove 121 is disposed on the side of the second main body part 120 facing the concha cavity. In this way, in the wearing state, the sliding projection 122 and the sliding groove 121 can be hidden in the concha cavity, which not only avoids the sudden sense of external vision, but also makes the overall appearance of the earphone 1000 smoother and simpler, and improves the aesthetics and fashion sense of the earphone 1000.

The sliding projection 122 and a housing of the sounding part 200 can be integrally formed or be separate structures. In a case where the sliding projection 122 and the housing of the sounding part 200 are integrated, connection stability between the sliding projection 122 and the housing of the sounding part 200 can be improved, and the risk of looseness or damages caused by long-term use or external force can be reduced. In addition, the stability and reliability of the sliding projection 122 in the sliding process can be ensured.

In a case where the sliding projection 122 and the housing of the sounding part 200 are separate parts, flexibility of the arranged position of the sliding projection 122 can be improved to adapt to the ear features and wearing habits of different users.

The embodiments of the present disclosure provide accurate guidance for the movement of the sounding part 200 by using the close cooperation between the sliding projection 122 and the sliding groove 121, which ensures the stability and accuracy of the sounding part 200 in the moving process and avoids the possible deviation or shaking of the sounding part 200 in the sliding process. At the same time, the sliding projection 122 and the sliding groove 121 are relatively simple to design, easy to manufacture and process, and production costs thereof are reduced.

Continuing to refer to FIG. 2 and FIG. 3, the shape of the sliding projection 122 is cylindrical, and the cylindrical sliding projection 122 has a smooth curved surface, which helps to reduce friction resistance with a sliding track of the second main body part 120, so that the sounding part 200 can slide on the second main body part 120 more smoothly.

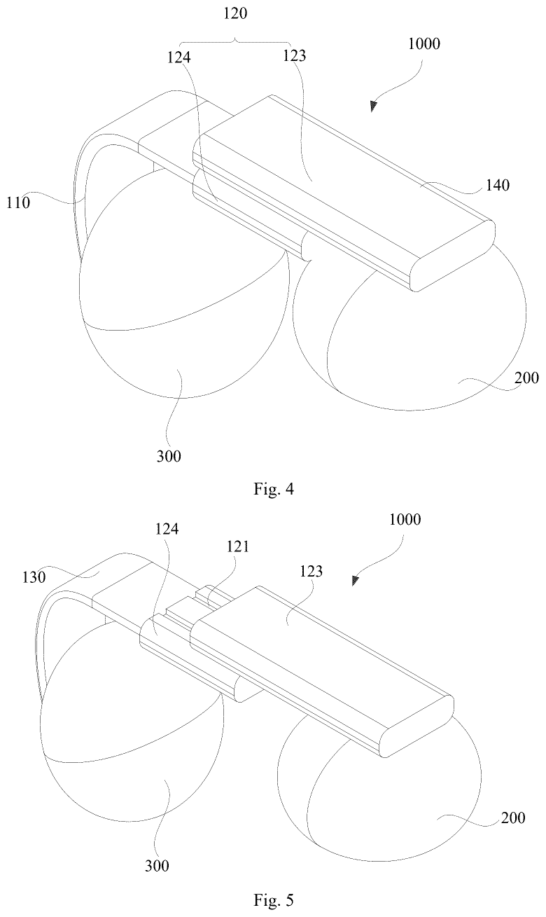

In one possible implementation, referring to FIGS. 4 and 5, the second main body part 120 includes a first sub-part 123 and a second sub-part 124. One end of the first sub-part 123 is connected with the sounding part 200, another end of the first sub-part 123 is connected with the second sub-part 124 in a sliding way, and the end of the second sub-part 124 facing away from the first sub-part 123 is connected with the first main body part 110.

In some embodiments, the first sub-part 123 and the housing of the sounding part 200 can be integrally formed, which can increase a volume of the first sub-part 123 and the housing of the sounding part 200, reduce assembly steps and decrease manufacturing difficulty.

It should be noted that the second sub-part 124 may be a part of the first main body part 110 facing the first sub-part 123, or in other words, a part of the first main body part 110 constitutes the second sub-part 124. The second sub-part 124 can also be a separate part. For example, the second sub-part 124 can be a hollow part, and the second sub-part 124 can be fitted over the first main body part 110. Thus, the second sub-part 124 and the first main body part 110 can be assembled after the sliding projection 122 or the sliding groove 121 is prepared on the second sub-part 124. On one hand, the size and shape of the second sub-part 124 can be flexibly determined according to actual needs, which increases the design flexibility of the earphone 1000, and on the other hand, if the second sub-part 124 or the sliding mechanism in the second sub-part 124 fails or needs maintenance, it can be easily removed from the first main body part 110, which improves the convenience of assembling and disassembling the earphone 1000.

In some embodiments of the present disclosure, one of the first sub-part 123 and the second sub-part 124 is provided with at least one sliding projection 122, and another of the first sub-part 123 and the second sub-part 124 is provided with at least one sliding groove 121. The at least one sliding groove 121 can further be provided with a limiting protrusion to limit a moving path of moving the at least one sliding projection 122.

Referring to FIG. 6, in which the number of the at least one sliding projection 122 and/or the at least one sliding groove 121 may be one or more. In an example, the number of the at least one sliding projection 122 or the number of the at least one sliding groove 121 is one, which can simplify the preparation of the at least one sliding projection 122 and the at least one sliding groove 121.

In another example, the at least one sliding groove 121 includes a plurality of sliding grooves, and the plurality of sliding grooves 121 are arranged at intervals; and/or, the at least one sliding projection 122 includes a plurality of sliding projections, and the plurality of sliding projections 122 are arranged at intervals. Taking arranging the at least one sliding groove 121 in the second sub-part 124 and arranging the at least one sliding projection 122 in the first sub-part 123 as an example, the description are made below.

The at least one sliding groove 121 includes a plurality of sliding grooves, and the plurality of sliding grooves 121 are arranged in the second sub-part 124 at intervals. Here, the number of at least one sliding projection 122 can be one, and according to the actual situation, the one sliding projection 122 can be appropriately adapted to cooperate with any one of the plurality of sliding grooves 121 so as to change the shape of the earphone 1000.

Accordingly, in a case where the at least one sliding projection 122 includes a plurality of sliding projections 122, and the plurality of sliding projections 122 are arranged in the first sub-part 123 at intervals, here, the number of at least one sliding groove 121 can be one, and according to the actual situation, any one of the plurality of sliding projections 122 can be appropriately adapted to cooperate with the one sliding groove 121.

Meanwhile, the number of the at least one sliding groove 121 and the number of the at least one sliding projection 122 may each be plural, with the plurality of sliding grooves 121 being arranged at intervals in the second sub-part 124 and the plurality of sliding projections 122 being arranged at intervals in the first sub-part 123. One sliding projection 122 is slidably arranged in one sliding groove 121, so that cooperation of the plurality of sliding grooves 121 and the plurality of sliding projections 122 can form a multi-point locking mechanism, and this design significantly improves the stability and reliability of the connecting portion. In addition, the multiple sliding connection points can effectively disperse the load acting on the connection points, avoid damages caused by excessive stress at a single point, and improve the service life of the earphone 1000.

It should be noted that in a case where the number of the at least one sliding groove 121 and the number of the at least one sliding projection 122 are each plural, the first sub-part 123 and the second sub-part 124 can each be provided with a plurality of sliding grooves 121 and a plurality of sliding projections 122. Since the sliding grooves and the sliding projections are respectively arranged on different sub-parts, cooperation between the sliding grooves and the sliding projections can be more compact and accurate. This design is helpful to reduce the friction and resistance in the sliding process and make the sliding action smoother and more stable.

Referring to FIG. 7, in the first state, the sounding part 200 is located at the side of the sliding groove 121 facing the first main body part 110, where the distance between the sounding part 200 and the ear canal opening 18 is relatively large. Here, the earphone 1000 can be an open earphone, which can reduce damages of the sounding part 200 to the ear canal and improve the wearing comfort of the earphone 1000.

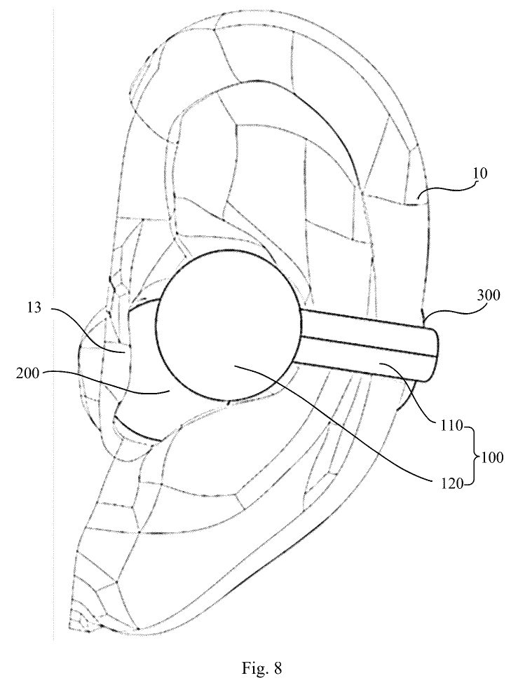

Referring to FIG. 8, in a case where it needs to improve the sound quality of the earphone 1000, the sounding part 200 can be controlled to move towards the concha cavity, and then the sliding projection 122 can move in the direction away from the first main body part 110 to reduce the distance between the sounding part 200 and the ear canal opening 18. Here, the earphone 1000 can be a semi-in-ear earphone or a full-in-ear earphone.

In this way, by simply moving the relative position of the sliding projection 122 in the sliding groove 121, the sounding part 200 can be freely switched between the first state and the second state. In other words, it can be easily switched from the wearing state of the open ear clip to the wearing state of the in-ear or semi-in-ear earphone, so as to realize the switching of the functional scene of the acoustic effect, thus giving consideration to the comfort of the open earphone without losing the sound quality effect of the semi-in-ear earphone or the full-in-ear earphone. In addition, the earphone 1000 also has the advantages of simple manufacturing principle, miniaturization and light weight.

Each embodiment or implementation in this specification is described in a progressive way, and each embodiment focuses on the differences from other embodiments, so it is only necessary to refer to the same and similar parts between each embodiment.

It should be noted that references to “one embodiment”, “embodiment”, “exemplary embodiment” and “some embodiments” in the specification mean that the described embodiments may include a specific feature, structure or characteristic, but not every embodiment necessarily includes the specific feature, structure or characteristic. Moreover, such phrases do not necessarily refer to the same embodiment. Furthermore, when a particular feature, structure or characteristic is described in connection with an embodiment, it is within the knowledge of those skilled in the art to realize such feature, structure or characteristic in connection with other embodiments that are explicitly or not explicitly described.

In the description of the embodiment of this disclosure, unless otherwise specified and limited, the terms “fixing”, “connected” and “connection” should be broadly understood, for example, they can be fixed connection, indirect connection through an intermediary, internal communication between two elements or interaction between two elements. For those skilled in the art, the specific meanings of the above terms in this disclosure can be understood according to the specific circumstances.

In the description of the embodiment of the present disclosure, the term “and/or” only means one kind of relationship describing the related objects, which means that there can be three kinds of relationships, for example, A and/or B, which can mean that A exists alone, A and B exist at the same time, and B exists alone. In addition, the term “at least one” means any one of a variety or any combination of at least two of a variety, for example, including at least one of A, B and C, and can mean any one or more elements selected from the set including A, B and C communication.

In the description of the embodiment of the present disclosure, the terms “first”, “second”, “third”, “fourth” and so on (if any) are used to distinguish similar objects, and are not necessarily used to describe a specific order or precedence. It should be understood that the data so used can be interchanged under appropriate circumstances, so that the embodiments of the disclosure described herein can be implemented in other orders than those illustrated or described herein.

Finally, it should be explained that the above embodiments are only used to illustrate the technical scheme of the disclosure but not to limit it; Although the present disclosure has been described in detail with reference to the foregoing embodiments, it should be understood by those skilled in the art that the technical scheme described in the foregoing embodiments can still be modified, or some or all of its technical features can be replaced by equivalents; However, these modifications or substitutions do not make the essence of the corresponding technical solutions deviate from the scope of the technical solutions of various embodiments of this disclosure.

What is claimed is:

1. An earphone, comprising a main body part and a sounding part, wherein in a wearing state, the main body part straddles a helix of an ear, and the sounding part is located at one side of the main body part facing a concha cavity of the ear,
wherein the sounding part is slidably arranged on the main body part to allow that the sounding part has a first state and a second state relative to the main body part, and a distance between the sounding part and an ear canal opening in the second state is smaller than a distance between the sounding part and the ear canal opening in the first state.

2. The earphone according to claim 1, wherein in the first state, the sounding part and the main body part clamp an ear, and in the second state, the sounding part extends below the tragus.

3. The earphone according to claim 2, wherein in the first state, at least part of the sounding part abuts against the concha cavity.

4. The earphone according to claim 1, wherein the main body part comprises a first main body part and a second main body part connected with the first main body part, and in the wearing state, the first main body part straddles the helix of the ear to allow that the second main body part and the sounding part extend towards the concha cavity of the ear, and the sounding part is slidably arranged on the second main body part.

5. The earphone according to claim 2, wherein the main body part comprises a first main body part and a second main body part connected with the first main body part, and in the wearing state, the first main body part straddles the helix of the ear to allow that the second main body part and the sounding part extend towards the concha cavity of the ear, and the sounding part is slidably arranged on the second main body part.

6. The earphone according to claim 3, wherein the main body part comprises a first main body part and a second main body part connected with the first main body part, and in the wearing state, the first main body part straddles the helix of the ear to allow that the second main body part and the sounding part extend towards the concha cavity of the ear, and the sounding part is slidably arranged on the second main body part.

7. The earphone according to claim 4, wherein one of the sounding part and the second main body part is provided with a sliding projection, another of the sounding part and the second main body part is provided with a sliding groove, and the sliding projection is slidably arranged in the sliding groove.

8. The earphone according to claim 7, wherein the sliding groove is arranged on one side of the second main body part facing the concha cavity.

9. The earphone according to claim 4, wherein the second main body part comprises a first sub-part and a second sub-part, one end of the first sub-part is connected with the sounding part, and another end of the first sub-part is slidably connected with the second sub-part.

10. The earphone according to claim 9, wherein one of the first sub-part and the second sub-part is provided with at least one sliding projection, and another of the first sub-part and the second sub-part is provided with at least one sliding groove.

11. The earphone according to claim 10, wherein the at least one sliding groove comprises a plurality of sliding grooves, and the plurality of the sliding grooves are arranged at intervals; and/or
the at least one sliding projection comprises a plurality of the sliding projections, and the plurality of sliding projections are arranged at intervals.

12. The earphone according to claim 7, wherein the earphone further comprises a balance part, and the balance part is connected with an end of the main body part away from the sounding part.

13. The earphone according to claim 8, wherein the earphone further comprises a balance part, and the balance part is connected with an end of the main body part away from the sounding part.

14. The earphone according to claim 9, wherein the earphone further comprises a balance part, and the balance part is connected with an end of the main body part away from the sounding part.

15. The earphone according to claim 10, wherein the earphone further comprises a balance part, and the balance part is connected with an end of the main body part away from the sounding part.

16. The earphone according to claim 11, wherein the earphone further comprises a balance part, and the balance part is connected with an end of the main body part away from the sounding part.
